(19) United States
(12) Patent Application Publication
(10) Pub. No.: US 2022/0251962 A1
(43) Pub. Date: Aug. 11, 2022

(54) GUIDE VANE HAVING A SUPPORT PORTION RIB

(71) Applicant: MTU Aero Engines AG, Munich (DE)

(72) Inventors: Markus SCHLEMMER, Munich (DE); Oliver THIELE, Munich (DE); Grzegorz BIALEK, Munich (DE); Marcin JASTRZEBSKI, Munich (DE)

(21) Appl. No.: 17/597,450

(22) PCT Filed: Jun. 8, 2020
(86) PCT No.: PCT/DE2020/000124

§ 371 Date: Jan. 6, 2022

(30) Foreign Application Priority Data
Jul. 8, 2019 (EP) 19184841.5

(51) Int. Cl. F01D 9/04

(52) U.S. Cl. CPC F01D 9/041; F05D 2240/12; F05D 2220/323

(57) ABSTRACT

A guide vane segment for a gas turbine having at least one guide vane, a radially inner covering strip and a radially outer covering strip, wherein the at least one guide vane extends between the inner covering strip and the outer covering strip. The inner covering strip and/or the outer covering strip having a respective support portion which extends in a circumferential direction (UR) and has a respective axial end face. The support portion comprises on the respective inner covering strip and/or the respective outer covering strip at least one support portion rib which extends in a radial direction, is connected to the support portion, and comprises a rib end face which merges into the axial end face of the support portion.

The present invention relates to a guide vane segment for a gas turbine, in particular an aircraft gas turbine, having at least one guide vane, a radially inner covering strip and a radially outer covering strip, wherein the at least one guide vane extends between the inner covering strip and the outer covering strip, and wherein the inner covering strip and/or the outer covering strip has/have a respective support portion which extends in the circumferential direction and which has a respective axial end face.

The direction indications, such as “axial”, or “axially”, “radial” or “radially” and “circumferential” are intended in principle to be understood to refer to the machine axis of the gas turbine, unless otherwise explicitly or implicitly indicated from the context.

The region of the covering strips is generally also used to clamp a guide vane segment in a processing device in order to be able to process, for example, to grind, the guide vanes in a desired manner. In this instance, as a result of the clamping and forces acting as a result of the processing operation are absorbed over the support portion or the end face which is supported in the processing device.

As a result of the forces acting during processing of a guide vane segment, undesirable cracks may occur in the support portion since very high-pressure forces act on the support portion.

The object on which the invention is based is to provide a guide vane segment in which the formation of cracks as a result of processing can be prevented.

This object is achieved by a guide vane segment having the features of patent claim 1 and a gas turbine having the features of patent claim 8. Advantageous embodiments with advantageous developments are set out in the dependent patent claims.

There is therefore proposed a guide vane segment for a gas turbine, in particular an aircraft gas turbine, having at least one guide vane, a radially inner covering strip and a radially outer covering strip, wherein the at least one guide vane extends between the inner covering strip and the outer covering strip, and wherein the inner covering strip and/or the outer covering strip has/have a respective support portion which extends in the circumferential direction and which has a respective axial end face. In this instance, there is provision for the support portion to have on the respective inner covering strip and/or on the respective outer covering strip at least one support portion rib which extends in a radial direction and which is connected to the support portion, in particular is formed integrally in one piece therewith, and which has a rib end face which merges into the end face of the support portion.

As a result of the support portion rib and the rib end face thereof, the forces which occur during processing of the guide vane segment can be better distributed and absorbed so that the formation of cracks can be counteracted. Furthermore, the support portion rib also has a reinforcement function for the support portion which is generally constructed to be rather thin in a radial direction.

The axial end face which adjoins the (respective) rib end face and which may be arranged axially at the front, axially at the rear, radially at the outer side or radially at the inner side may have a maximum radial extent of 5 mm, in particular 2 mm.

The rib end face and the end face of the support portion may be constructed in a planar manner with respect to each other. There is thereby produced a planar and continuously increased support face which is formed by the end face and the rib end face. As a result of the increase of the overall available surface via which forces can be transmitted, there is produced a better force distribution within the support portion so that the formation of cracks can be counteracted.

The rib end face and the end face on the radially inner covering strip and/or on the radially outer covering strip may form with a support face on the other of the inner and outer covering strip, which support face may include the other end face or rib end face and end face, a support face of the guide vane segment which is located within a common plane and by means of which the guide vane segment can be supported in an axial direction on a planar substrate. That is to say, the end face(s) and the rib end face(s) may form support and/or contact faces by means of which the guide vane segment, in particular when it is clamped for the processing in a processing apparatus, can be supported on a planar substrate, which extends parallel or substantially parallel with the circumferential and radial direction, in particular with surface contact between the support face and the planar support face. The support face thus preferably forms an axial interface of the guide vane segment.

In a development, the guide vane segment comprises both such an axially front (upstream) and such an axial rear (downstream) support face which both comprise one or more rib end faces on the inner covering strip and/or on the radially outer covering strip.

The rib end face of a support portion rib may correspond to approximately from 2% to 15%, preferably approximately from 6% to 12%, of the end face of the support portion. In other words, the support face available is thus increased by approximately from 2 to 15% by the provision of a support portion rib.

The guide vane segment may have three or more guide vanes.

The at least one support portion rib may be formed with respect to the extent of the support portion in the circumferential direction in the center of the support portion. Alternatively, the guide vane segment has two or more support portion ribs which are arranged in a state distributed along the support portion, in particular are arranged in a state distributed in a regular manner. Accordingly, the arrangement of support portion ribs may be carried out in accordance with the configuration of the guide vane segment, in particular the extent thereof in a circumferential direction and the sizing of the support portion. It is thereby ensured that the additional rib end face is provided at appropriate locations in order to be able to distribute the active forces in the most effective manner possible.

The at least one support portion rib, in particular all the support portion ribs, may be formed on the side of the respective covering strip which faces away from a gas channel. It is thereby ensured that the additional support portion rib(s) do/does not impair the flow in a gas turbine.

The above object is also achieved with a gas turbine, in particular an aircraft gas turbine, having at least one guide vane ring which is provided at the compressor side or at the turbine side and which is formed by a plurality of guide vane segments which are arranged beside each other in a circumferential direction, as described above. With regard to the gas turbine, which has a guide vane ring having such guide vane segments, it should also be noted that the support portion ribs have no purpose or function during operation of a gas turbine. The weight increase which is brought about by the support portion ribs in a guide vane segment may be considered to be negligible, in particular also from the point of view that the formation of cracks and consequently costly repairs or replacement of guide vane segments can be prevented.

The invention is described below by way of example and in a non-limiting manner with reference to the appended Figures in which:

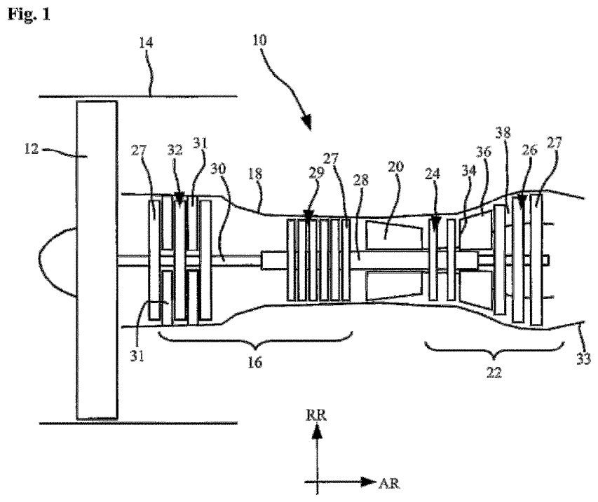

FIG. 1 is a simplified, schematic illustration of a basic diagram of an aircraft gas turbine;

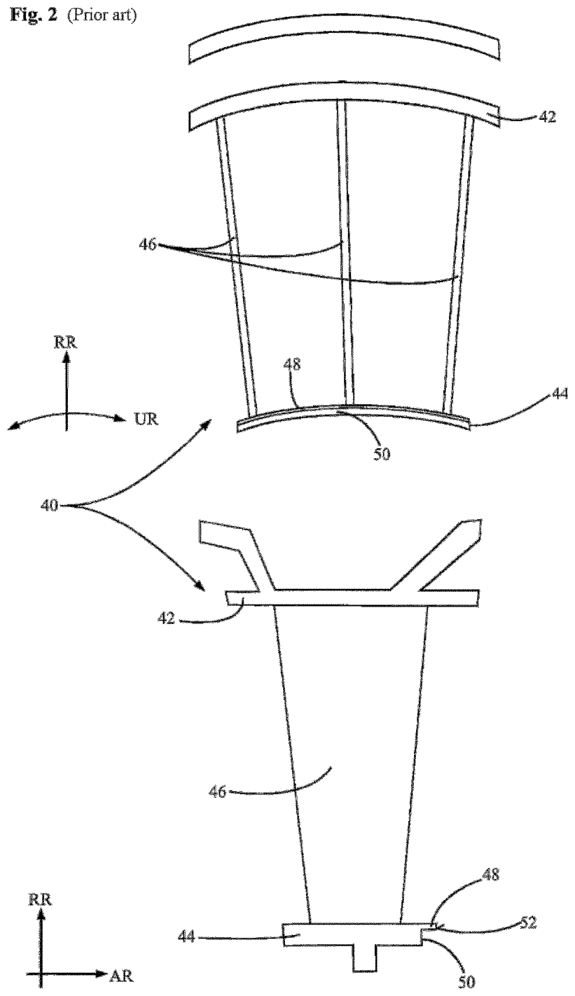

FIG. 2 is a simplified and schematic front and side view of a known guide vane segment with a support portion on the radially inner covering strip;

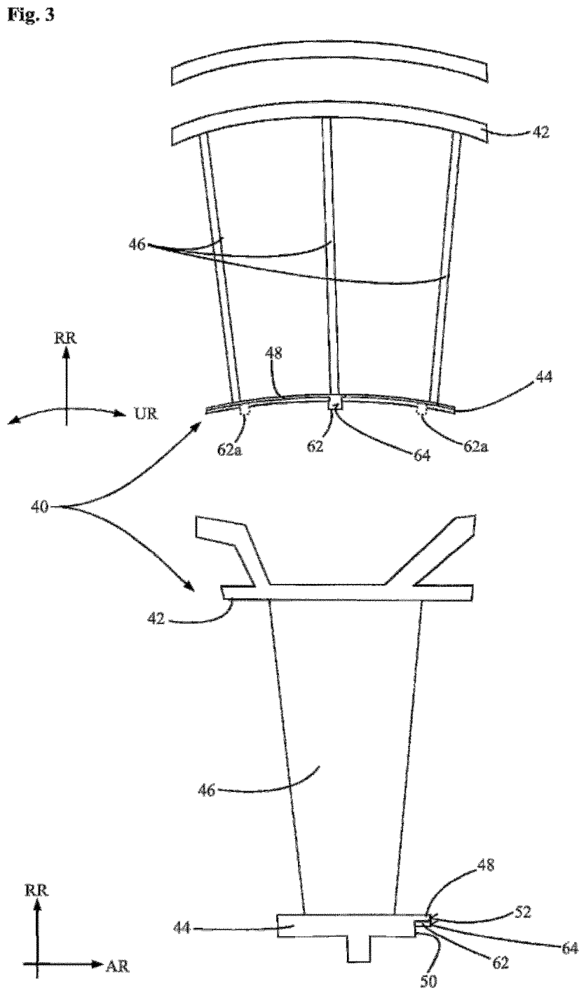

FIG. 3 is a simplified and schematic front and side view of an example of a guide vane segment with a support portion with a support portion rib.

FIG. 1 is a schematic and simplified illustration of an aircraft gas turbine 10 which is illustrated purely by way of example as a turbofan engine. The gas turbine 10 comprises a fan 12 which is surrounded by an indicated cover 14. In an axial direction AR of the gas turbine 10, the fan 12 is adjoined by a compressor 16 which is received in an indicated inner housing 18 and which may be constructed with a single stage or multiple stages. The compressor 16 is adjoined by the combustion chamber 20. Hot exhaust gas which flows out of the combustion chamber then flows through the adjacent turbine 22 which may be constructed with one stage or several stages. In the present example, the turbine 22 comprises a high-pressure turbine 24 and a low-pressure turbine 26. A hollow shaft 28 connects the high-pressure turbine 24 to the compressor 16, in particular a high-pressure compressor 29, so that they are driven or rotated together. A shaft 30 which is located further inside in a radial direction RR of the turbine connects the low-pressure turbine 26 to the fan 12 and to a low-pressure compressor 32 so that they are driven or rotated together. The turbine 22 is adjoined by a thruster 33 which is only indicated here.

In the example illustrated of an aircraft gas turbine 10, there is arranged between the high-pressure turbine and the low-pressure turbine 26 an intermediate turbine housing 34 which is arranged around the shafts 28, 30. In the radially outer region 36 thereof, hot exhaust gases from the high-pressure turbine 24 flow through the intermediate turbine housing 34. The hot exhaust gas then reaches an annular space 38 of the low-pressure turbine 26. Of the compressors 28, 32 and the turbines 24, 26, rotor blade rings 27 are illustrated by way of example. Rotor blade rings 31 which are generally provided are illustrated for reasons of clarity by way of example only in the compressor 32.

The following description of an embodiment of the invention relates in particular to guide vane segments which form a guide vane ring for the turbines 24, 26 or the compressors 28, 32.

FIG. 2 is a simplified and schematic perspective illustration of a known guide vane segment 40. The guide vane segment 40 has a radially outer covering strip 42 and a radially inner covering strip 44. In the shown example, three guide vanes 46 extend between the covering strips 42, 44. The radially inner covering strip 44 has a support portion 48 which extends in the circumferential direction UR. The support portion 48 protrudes in an axial direction AR over an edge portion 50 of the inner covering strip 44. An end face 52 of the support portion 48 is generally orientated substantially orthogonally with respect to the axial direction AR and extends in a plane which is defined by the circumferential direction UR and the radial direction RR.

For the sake of completeness, it should also be noted that it is possible to see radially at the inner side on the inner covering strip 44 securing portions 54 which serve to connect the guide vane segment 40 to additional structural components of the gas turbine which are not illustrated. There are also shown radially at the outer side on the outer covering strip securing structures 56 which serve to secure the guide vane segment 40 inside the gas turbine. Furthermore, respective cooling lines 58, 60 are also illustrated on the two covering strips 42, 44.

When a guide vane segment 40 is processed by means of a processing apparatus which is not shown in this instance, for example, ground, the guide vane segment 40 can be clamped in the region of the inner covering strip 44 in the processing apparatus. In this instance, the support portion 48 is positioned with the end face 42 thereof on a corresponding counter-piece of the processing apparatus and is acted on with pressure for clamping.

With reference at the same time to the various illustrations of FIG. 3, an example of a guide vane segment 40 according to the invention is described below. The guide vane segment 40 has substantially the structure which is described above with reference to FIG. 2, for which reason the same reference numerals are also set out in FIG. 3 as in FIG. 2, but without them being described again.

In the guide vane segment 40, a support portion rib 62 is formed on the support portion 48. The support portion rib 62 is connected to the support portion 48, in particular connected in one piece or formed integrally therewith. The support portion rib 62 has a rib end face 64 which also extends substantially orthogonally with respect to the axial direction AR and which is located in a plane defined by the circumferential direction UR and the radial direction RR.

The rib end face 64 and the end face 52 of the support portion 48 together form a continuous or entire support face 66. As a result of the provision of at least one support portion rib 62, the overall support face which is available can be increased. In this instance, the rib end face which is additionally provided by the support portion rib 62 has an area which corresponds to approximately from 2% to 15%, preferably approximately from 6% to 12%, of the area of the end face 50 of the support portion 48. If a known guide vane segment 40 according to FIG. 2 is assumed, in which the end face 52 of the support portion has an area which corresponds to 100%, the entire support face 66 which is formed by the end face 52 and the rib end face 64 has an area which corresponds to from 1.02 times to 1.15 times the area of the end face 52.

As can be seen in the illustrations of FIG. 3, the end face 50 and the rib end face 64 may be formed in a planar manner with respect to each other, that is to say, they are located in the same plane. As a result of the increase in the support face, when the guide vane segment 40 is clamped in the processing apparatus, the active forces can be better distributed so that no cracks are formed in the support portion 48.

With regard to FIG. 5, it should again be noted that the support portion rib 62 may be arranged in a circumferential direction in the center length of the support portion 48. The provision of a support portion rib 62 is only an example and two or more support portion ribs may also be provided. Purely by way of example, two additional support portion ribs 62a are illustrated with dashed lines in FIG. 5. A guide vane element 40 could consequently only the support portion rib 62a or only the support portion ribs 62a or all three support portion ribs 62, 62a. Of course, a guide vane element which extends over a relatively large region in the circumferential direction UR and which where applicable also has more guide vanes may also have more support portion ribs. Accordingly, the overall support face 66 which is available can be further increased by the provision of a plurality of support portion ribs 62, 62a.

### LIST OF REFERENCE NUMERALS

10 Aircraft gas turbine
12 Fan
14 Cover
16 Compressor
18 Inner housing
20 Combustion chamber
22 Turbine
24 High-pressure turbine
26 Low-pressure turbine
28 Hollow shaft
29 High-pressure compressor
30 Shaft
31 Guide vane ring
32 Low-pressure compressor
33 Thruster
34 Intermediate turbine housing
36 Radially outer region
38 Annular space
40 Guide vane segment
42 Radially outer covering strip
44 Radially inner covering strip
46 Guide vane
48 Support portion
50 Edge portion
52 End face
62, 62a Support portion rib
64 Rib end face
AR Axial direction
RR Radial direction
UR Circumferential direction

1.-10. (canceled)

11. A guide vane segment for a gas turbine having at least one guide vane, a radially inner covering strip and a radially outer covering strip, wherein the at least one guide vane extends between the inner covering strip and the outer covering strip, the inner covering strip and/or the outer covering strip having a respective support portion which extends in a circumferential direction (UR) and has a respective axial end face, and wherein
the support portion comprises on the respective inner covering strip and/or on the respective outer covering strip at least one support portion rib which extends in a radial direction (RR), is connected to the support portion, and comprises a rib end face which merges into the axial end face of the support portion.

12. The guide vane segment of claim 11, wherein the segment is suitable for use in an aircraft gas turbine.

13. The guide vane segment of claim 11, wherein the at least one support portion rib is formed integrally in one piece with the support portion.

14. The guide vane segment of claim 11, wherein the axial end face which adjoins the rib end face has a maximum radial extent of 5 mm.

15. The guide vane segment of claim 11, wherein the axial end face which adjoins the rib end face has a maximum radial extent of 2 mm.

16. The guide vane segment of claim 11, wherein the rib end face and the axial end face of the support portion are constructed in a planar manner with respect to each other.

17. The guide vane segment of claim 11, wherein the rib end face and the axial end face on the inner covering strip and/or on the outer covering strip form with a support face on the other one of the inner and outer covering strip a support face of the guide vane segment which is located within a common plane and by means of which the guide vane segment can be supported in an axial direction on a planar substrate.

18. The guide vane segment of claim 11, wherein the rib end face of a support portion rib corresponds to from about 2% to about 15% of the axial end face of the support portion.

19. The guide vane segment of claim 11, wherein the rib end face of a support portion rib corresponds to from about 6% to about 12% of the axial end face of the support portion.

20. The guide vane segment of claim 11, wherein the guide vane segment comprises three or more guide vanes.

21. The guide vane segment of claim 11, wherein the at least one support portion rib is formed with respect to an extent of the support portion in a circumferential direction (UR) in a center of the support portion.

22. The guide vane segment of claim 11, wherein the guide vane segment comprises two or more support portion ribs which are arranged in a state distributed along the support portion.

23. The guide vane segment of claim 11, wherein the guide vane segment comprises two or more support portion ribs which are arranged in a state distributed along the support portion in a regular manner.

24. The guide vane segment of claim 11, wherein the at least one support portion rib is formed at a the side of the respective covering strip which faces away from a gas channel.

25. The guide vane segment of claim 23, wherein all support portion ribs are formed at a the side of the respective covering strip which faces away from a gas channel.

26. A gas turbine, wherein the gas turbine comprises at least one guide vane ring which is provided at a compressor side or at a turbine side and is formed by a plurality of guide vane segments which are arranged beside each other in a circumferential direction (UR) in accordance with claim 11.

27. The gas turbine of claim 26, wherein the gas turbine is an aircraft gas turbine.
